(19) United States
(12) Patent Application Publication
(10) Pub. No.: US 2018/0304399 A1
(43) Pub. Date: Oct. 25, 2018

(54) ADDITIVE MANUFACTURING APPARATUS USING ELECTRON BEAM MELTING

(71) Applicant: HTL Co. Japan Ltd., Tokyo (JP)

(72) Inventor: Ryuji Tatsumi, Tokyo (JP)

(73) Assignee: HTL Co. Japan Ltd., Tokyo (JP)

(21) Appl. No.: 15/956,748

(22) Filed: Apr. 19, 2018

(30) Foreign Application Priority Data
Apr. 19, 2017 (JP) 2017-082557

(51) Int. Cl. B23K 15/00; B33Y 30/00

(52) U.S. Cl. CPC B23K 15/0086; B23K 15/002; B23K 15/0013; B33Y 30/00

(57) ABSTRACT

In an additive manufacturing apparatus using electron beam melting for manufacturing three-dimensional structures by laminating layers in which metal powder is selectively molten-solidified with electron beam, defect in current apparatus is to be removed such that electrons accelerated with a constant accelerating voltage are irradiated irrespective of filling rate or density of metal powder to be used for additive manufacturing. Voltage of power supply applied between a grid and an anode provided in an electron gun for generating electron beam is varied corresponding to filling rate and/or density of metal powder. With this, velocity of electron such that a position where thermal energy becomes maximum is taken as most suitable can be obtained.

### CROSS REFERENCE TO RELATED APPLICATIONS

This application claims the priority benefit of Japanese Patent Application No. 2017-82557, filed on Apr. 19, 2017. The entirety of the above-mentioned patent application is hereby incorporated by reference herein and made a part of this specification.

### TECHNICAL FIELD

The present disclosure relates to an additive manufacturing apparatus using electron beam melting.

### BACKGROUND ART

Additive manufacturing apparatus using electron beam melting (also referred to as “EBM”) for manufacturing three-dimensional structures by laminating layers in which metal powder is selectively molten-solidified with an electron beam are conventionally known as disclosed in Patent Document 1.

Patent Document 1: Japanese Unexamined Patent Publication No. 2015-167125

### SUMMARY

In a three-dimensional additive manufacturing apparatus using an electron beam as an energy source, additive manufacturing is performed in a manner such that voltage is applied between a grid and an anode of an electron beam gun for generating the electron beam, electrons accelerated to about a half of velocity of light are caused to collide against a metal particle layer and heat energy converted from kinetic energy that has been generated at this time causes metal particles to be molten.

In this process, an electron has electric charge of −1.0602176×10⁻¹⁹ C and, for example in case of a current of 10 mA, about a number of 6.242×10¹⁶ electrons collide against metal powder with a high velocity.

A metal powder particle is a solid body. Although no void can be seen in it macroscopically, there are plenty of voids between a nucleus and outer-shell electrons in a metal atom or between an atom and another atom.

Electrons having penetrated into a metal particle with a high velocity repeat access to or collision against outer-shell electrons of metal atoms and are deprived of kinetic energy, which is converted into heat energy.

With a distance between two electrons in an atom being p, a collision cross section σ for a charged electron becomes as follows.

σ=πp² Eq. (1)

For a charged electron moving by a fine distance δx,

(probability of interference of the charged electron with an electron in an atom)=(collision cross section σ)×(target density N)×(distance δx of electron movement) Eq. (2)

From the above equation, the following is derived.

(collision probability of an electron when it has moved in to a distance x)=1−exp(−σNx) Eq. (3)

When an electron with a high velocity collides against or passes near an electron in a metal particle, interference occurs. That is, coulomb repulsion acts from an electron belonging to an atom, due to which a part of the kinetic energy that the electron with a high velocity has is deprived of to be transferred to an atom, thus converted into thermal energy.

For this, in a position of an electron that has moved with a velocity v from the nearest access point, coulomb repulsion (Fox) to the electron amounts to Q₁Q₂/(p²+(vt)²). Here, Q₁, Q₂ are electric charges of a charged electron and of a charged particle of an atom respectively.

Hence, the repulsion F(t) becomes as follows.

F(t)=∫{Q₁Q₂δx/(p²+(vt)²)}dx=(Q₁Q₂δx/vp)arctan(vt/p) Eq. (4)

From Eq. (4), conversion into thermal energy does not so increase when the electron has a high velocity, as it is in inverse proportion to the velocity of the electron with a high velocity.

When kinetic energy of the electron is deprived of and velocity of the electron becomes lowered, energy conversion by interference increases.

Further, Eq. (3) shows that target density, that is, value of metal atom density N is related to reaching distance of an electron.

In such a manner, when an electron with a high velocity penetrates into metal, collision is maximized in a deeper position, where kinetic energy is deprived of to be converted into thermal energy.

FIG. 1 shows a manner of this heat generation. As seen in FIG. 1, amount of generated heat becomes maximum not in the surface of metal, but in a somewhat deep position. In what position amount of generated heat becomes maximum is decided by velocity of an accelerated electron and density of electrons or nuclei in the material against which the accelerated electron collides.

It is extremely important to control the position where amount of generated heat becomes maximum, in order to perform favorable three-dimensional additive manufacturing.

For example, in a case in which maximum heat generation occurs in a very deep position, as shown in FIG. 2, melting begins at this position and after then transferred to periphery through conduction of heat, so that temperature becomes lowered. In this case, there may be a case in which melting does not reach the surface of metal and melting is insufficient near the surface, as shown in FIG. 3.

In a case of electron beam welding, there is an occasion in which a target is fixed and an electron beam continues to be irradiated only to a same position. It is known that, in such a case, keyholes are created through melting by electron beam so that melting reaches a deep position.

On the other hand, additive manufacturing is generally performed by scanning a beam to melt metal powder in a three-dimensional additive manufacturing. Due to this, there is no occasion of creating a keyhole as is in welding and condition of melting is decided by number of electrons irradiated onto a certain area and energy of each individual electron, as well as density, thermal conductivity, specific heat, etc., of metal as a target.

Regarding this, control of depth of heat generation center has been studied, remarking depth of heat generation center shown in FIG. 2.

It is known that there is a correlation among atomic weight and atomic radius of metal atom and density of metal.

Regarding this correlation, it was shown with Eq. (3) that, when an electron penetrating with a high velocity near to the velocity of light interacts with metal atoms, probability of the interaction depends on density of atoms.

As apparent from Eq. (3), depth through which interaction of an electron with metal atoms occurs is different between a low density metal as aluminum and a high density metal as iron or nickel.

Here, accelerating voltage of an electron gun is fixed to a constant value for a current commercially available additive manufacturing apparatus using electron beam melting. With such, favorable results of three-dimensional additive manufacturing are attained for titanium alloy or nickel alloy. For aluminum alloy, on the other hand, problems such as creation of cracks are left to remain with an apparatus using electron beam as heat source, while certain results are attained with an apparatus using laser as heat source.

Although trials are made with temperature of preliminary heating or value of current, that is, number of irradiated electrons per time taken as parameters in order to solve such problems, favorable results have not been attained yet.

The cause of this is considered to consists in that reached depth of an electron becomes long and maximum exothermic area is disposed in a deep position with a low density metal like aluminum, so that explosive melting occurs in which internal molten substance spurts to surface.

For solving the problems, it is necessary to control exothermic position to be suitable.

As explained above, position at which an accelerated electron having penetrated into metal generates maximum quantity of heat depends on velocity of the electron and density of metal.

From this fact, it cannot be said to be suitable to melt metal materials with a same accelerated electron beam for a high density metal material like iron or nickel and a low density metal material like aluminum.

Further, with an additive manufacturing apparatus using electron beam melting, additive manufacturing is performed through heating-melting metal powder with accelerated electrons.

While powder of 20 μm to 200 μm is used mainly, voids are formed among particles of metal powder as shown in FIG. 4, when this metal powder is caused to have a laminar shape.

Electron beam advancing through vacuum can go straight as there is nothing interfering in the voids.

Consequently, amount of voids is related to depth of interaction along with density of metal, in case of irradiation of electron beam onto a metal powder layer with an actual additive manufacturing apparatus.

As such, because a conventional additive manufacturing apparatus provides only a fixed accelerating voltage in performing three-dimensional electron beam melting, position of maximum heat generation is various according to density of metal, so that it was difficult to establish most suitable condition of melting for metal materials or powder.

The present disclosure has been devised under such background and the present disclosure provide embodiments for irradiating electrons accelerated with a constant accelerating voltage irrespective of density of metal materials with which additive manufacturing is to be performed in a three-dimensional additive manufacturing apparatus using electron beam in a method of metal powder bed, which solves defects in conventional three-dimensional additive manufacturing apparatus.

The present disclosure employs following embodiments in order to solve the problems explained above. Here, reference signs with parentheses used in the following explanation of embodiments and figures are added for convenience in consideration but composing elements of the present disclosure are not limited by ones with such reference signs added.

That is, a first embodiment according to the disclosure is an additive manufacturing apparatus using electron beam melting comprising:

an optical system for an electron beam 1 used as energy source that scans and converges the electron beam in two-dimensions (in the face 11) according to additive manufacturing data created to have a layout of a three-dimensions CAD data of at least one entity to be additively manufactured, and

a start plate 12 for holding a metal powder on an upper face, which is disposed in a face where the electron beam converges, of a raising and lowering mechanism;

the additive manufacturing apparatus being configured so as to form a layer by dispersing the metal powder onto the start plate, smoothing the metal powder to be flat with a rake 10 and scanning the electron beam in two-dimensions to melt the metal powder, and further by laminating the formed layers successively through lowering the raising and lowering mechanism to perform additive manufacturing of the entity,

wherein a voltage of a power supply applied between a grid 3 and an anode 4 provided in an electron gun generating the electron beam capable of being varied corresponding to a filling rate and/or a density of the metal powder.

Further, a second embodiment according to the disclosure is an additive manufacturing apparatus using electron beam melting according to the first embodiment, wherein the filling rate is obtained including voids among particles of the metal powder by filling a rectangular cup having a standard volume for measuring (shown in FIG. 6) with the metal powder to be molten and measuring weight of the metal powder.

With the first embodiment, velocity of an electron, with which position where thermal energy converted from kinetic energy that an electron having penetrated into metal powder has been deprived of through collision against metal atoms becomes maximum is taken as most suitable, can be set by changing accelerating voltage corresponding to filling late of metal powder or density (that is, kinds of metal materials).

With the second embodiment, while voids are formed among particles of metal powder when metal powder has been spread to be laminar with a rake as shown in FIG. 4, electron beam has nothing interfering with it and can advance in a straight manner because the voids are in vacuum, so that the voids can be taken as corresponding to having no distance for an electron with a high velocity. Due to this, it is possible to set velocity of an electron and decide accelerating voltage considering filling rate of metal powder layer along with density of metal materials.

### BRIEF DESCRIPTION OF THE DRAWINGS

FIG. 1 is a schematic view showing a situation of heat generation.

FIG. 2 is a schematic view showing a case where position of maximum heat generation amount is very deep.

FIG. 3 is a schematic view showing a situation in which melting near surface of metal is insufficient with melting not reaching the surface.

FIG. 4 is a schematic view showing a situation of metal powder formed to be laminar.

FIG. 5 is a schematic view showing a main composition of an additive manufacturing apparatus using electron beam according to an embodiment of the present disclosure.

FIG. 6 is a view showing a rectangular cup for measuring filling rate at the time when metal powder is dispersed.

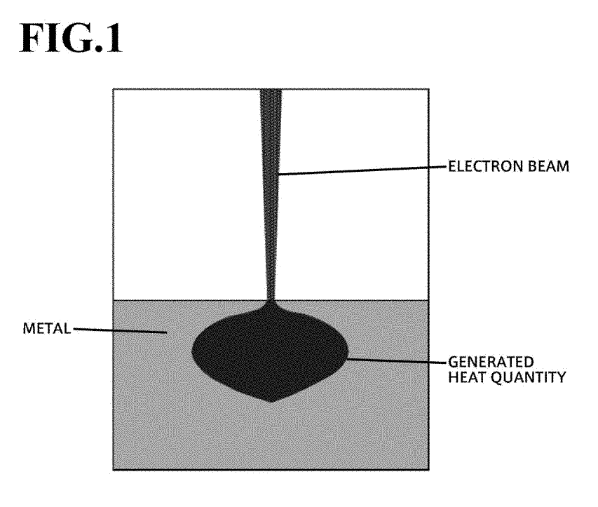

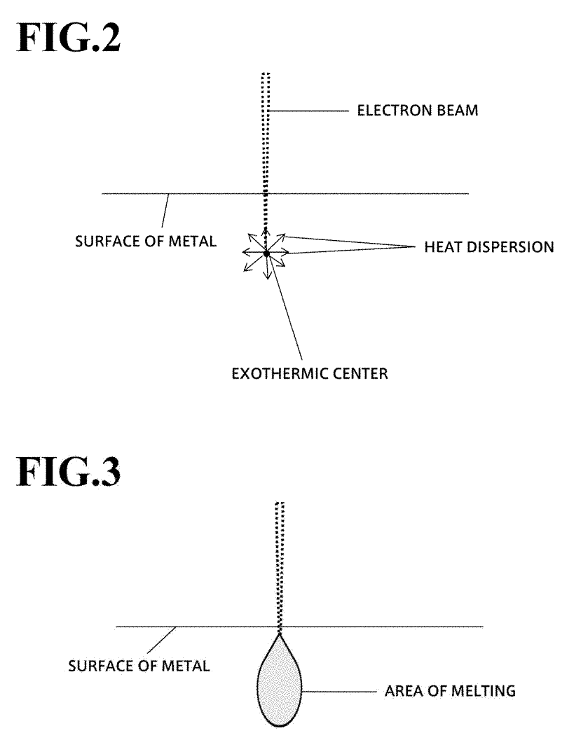

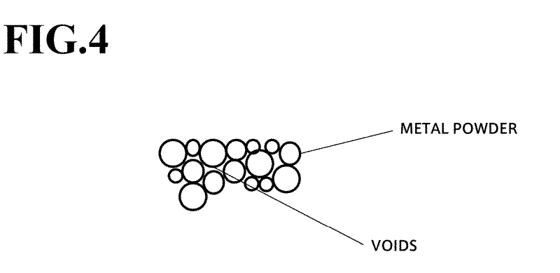

### DESCRIPTION OF EMBODIMENTS

Embodiments of the present disclosure will be explained in detail referring to figures.

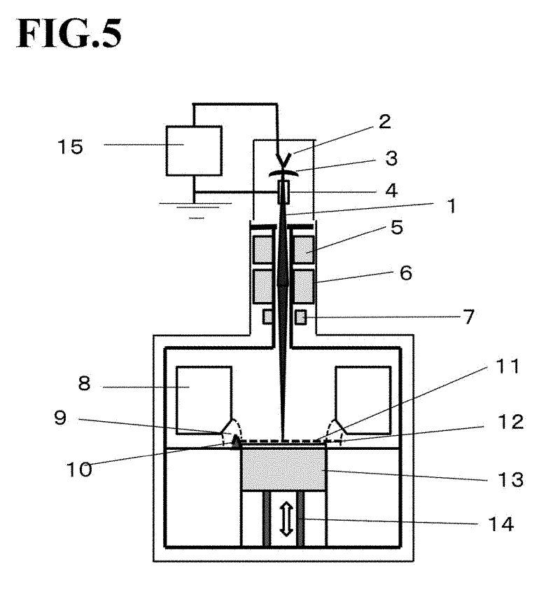

FIG. 5 is a schematic view showing a main composition of an additive manufacturing apparatus using electron beam according to an embodiment of the present disclosure. With this additive manufacturing apparatus using electron beam, an electron gun comprising a filament 2, a grid 3 and an anode 4 is used as an energy source. The additive manufacturing apparatus comprises: an optical system for electron beam equipped with a scanning coil 6 for scanning electron beam 1 in two-dimensions and a converging coil 7 for converging the electron beam 1 according to an additive manufacturing data created to have a layout of a three-dimensions CAD data of at least one entity to be additively manufactured; and a start plate 12 for holding metal powder on the upper face, which is disposed in the face 11 where the electron beam converges, of an additive manufacturing box 13 placed on a raising and lowering mechanism 14. Thus, the additive manufacturing apparatus is configured such that metal powder 9 supplied from a powder hopper 8 is dispersed onto the start plate 12 and smoothed to be flat with a rake 10, after which irradiated electron beam 1 is scanned in two-dimensions to melt the metal powder. The additive manufacturing apparatus in this basic configuration has a feature such that voltage of a power supply 15 applied between the grid 3 and anode 4 is varied corresponding to density of metal materials used for additive manufacturing in order to set most suitable accelerating voltage corresponding to density of materials with which additive is to be performed.

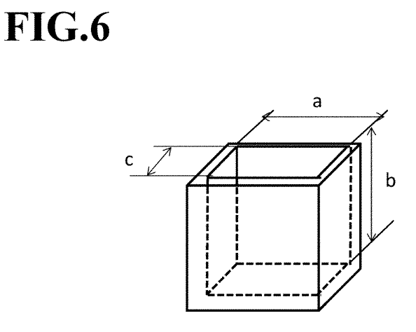

FIG. 6 shows a rectangular cup for measuring filling rate of metal powder at the time when it is dispersed to be a layer, with which condition of voids among particles according to size or shape of metal particles can be known.

With a currently used apparatus having a fixed electron accelerating voltage for a standard metal, accelerating voltage necessary for a novel metal powder can be obtained from reaching depth of a novel metal powder considering density of a standard metal powder (no), density of a novel metal powder (n₁) and reaching depth of a standard metal material.

Relativistic expression of conservation of energy is as follows.

E=(m₀²c⁴+p²c²)^{1/2}=m₀c²+ev

Here, c: velocity of light, e: charge of an electron, m₀: rest mass of an electron.

And, momentum p is expressed in relativistic manner as follows.

p=m₀v/{1−(v/c)²}^{1/2}.

Here, v is velocity of an electron.

From the two equations, the following is obtained.

eV=m₀c²{c²/(c²−v²)^{1/2}−1}

From this equation, the following can be obtained.

v=c(eV(2m₀c²+eV))^{1/2}/(m₀c²+eV) Eq. (5)

After filling a rectangular cup for measuring of a volume (a×b×c) as shown in FIG. 6 with metal powder having a density (n₁) used for additive manufacturing, the mass (w) of the metal powder is measured and filling rate (j) of the metal powder is calculated from the following equation.

j=w/(abc)n₁ Eq. (6)

As an electron having penetrated into the metal powder advances repeating collision or interference with atoms of the metal, the reaching depth (D) is proportional to a function F(v) of velocity of the electron and in inverse proportion to a function F(n) and filling rate of the metal powder (j). That is,

D=F(v)/jF(n₁)=abcF(v)/wF(n₁)

Here, taking reaching depth (D) of the electron as reaching depth (D₀) of a standard metal,

D₀=F(v₀)/j₀F(n₀)

For making reaching depth of an electron of material with which additive manufacturing is to be performed equal to reaching depth D₀ of a standard metal, the following needs to be satisfied with.

D₀=F(v)/jF(n₁)=F(v₀)/j₀F(n₀)

From this, the following can be obtained.

F(v)=jF(n₁)F(v₀)/j₀F(n₀) Eq. (7)

From Eq. (7), velocity v of an electron necessary for additive manufacturing of material used for additive manufacturing with density n₁ and filling rate j so as to have reaching depth of an electron equal to that of a standard material can be calculated.

According to Eq. (5), velocity of an electron can be obtained from accelerating voltage applied to a standard material. Hence, accelerating voltage of material for additive manufacturing can be obtained by applying the result of Eq. (7) to Eq. (5).

Melting with most suitable depth can be attained by applying accelerating voltage for novel material obtained here with the power supply (15) shown in FIG. 5.

Specifically, in a case where 6-4 titanium with particle diameter distribution of 40 μm to 120 μm is used as a basic material for an actual additive manufacturing apparatus, filling rate measured with a rectangular cup for measuring of a volume 2 cm×2 cm×2.5 cm is 0.98, density is 4.43 g/cm³ and used accelerating voltage is 60 kV.

On the other hand, in a case where aluminum with same particle diameter distribution is used as a novel material, filling rate measured with same rectangular cup is 0.98 and density is 2.70 g/cm³, so that accelerating voltage of 21 kV is suitable.

In this, accelerating voltage may be set by selectively changing from preliminarily established values for material such as 60 kV, 21 kV, etc. or accelerating voltage may be arbitrarily variable in certain range.

The above example has been explained in which accelerating voltage is varied based on both of filling rate and density of metal powder. However, not limited by this, accelerating voltage may be varied based on either one of filling rate and density. For example, if filling rate of a novel material is near to that of a standard material, it may be sufficient to vary accelerating voltage based on density of the novel material. On the other hand, if density of a novel material is near to that of a standard material, it may be sufficient to vary accelerating voltage based on filling rate of the novel material. That is, it may be sufficient to vary accelerating voltage corresponding to filling rate and/or density of metal powder.

What is claimed is:

1. An additive manufacturing apparatus using electron beam melting, comprising:
an optical system for an electron beam used as an energy source that scans and converges the electron beam in two-dimensions according to an additive manufacturing data created to have a layout of a three-dimensions CAD data of at least one entity to be additively manufactured, and
a start plate, holding a metal powder on an upper face, which is disposed in a face where the electron beam converges, of a raising and lowering mechanism;
wherein the additive manufacturing apparatus is configured to form a layer by dispersing the metal powder onto the start plate, smoothing the metal powder to be flat with a rake and scanning the electron beam in two-dimensions to melt the metal powder, and further by laminating the formed layers successively through lowering the raising and lowering mechanism to perform additive manufacturing of the entity,
wherein a voltage of a power supply applied between a grid and an anode provided in an electron gun generating the electron beam capable of being varied corresponding to a filling rate and/or a density of the metal powder.
